(19) United States
(12) Patent Application Publication
(10) Pub. No.: US 2004/0187264 A1
(43) Pub. Date: Sep. 30, 2004

(54) Hinge

(75) Inventor: Yung-Shun Chuang, Hsin-Tien City (TW)

Correspondence Address: RABIN & BERDO, P.C., Suite 500, 1101 14 Street, N.W., Washington, DC, 20005, US

(73) Assignee: AAEON TECHNOLOGY INC., Hsin-Tien City (TW)

(21) Appl. No.: 10/400,451

(22) Filed: Mar. 28, 2003

(51) Int. Cl. E05D 5/12

(52) U.S. Cl. 16/380

(57) ABSTRACT

Disclosed is a hinge comprising a shaft including an enlarged head, a cylindrical body, flats equally spaced apart around the body, and a threaded bore in the body; a paw including an abutment member, elongate elastic members curved outward from the abutment member, and a hole through the abutment member; and a fastener. The paw is clung to the body with the elastic members aligned with the corresponding flats. The fastener is driven through the hole into the bore to fasten the shaft and the paw. The fastener can be driven through the cover and the container to compress the elastic members inward until the open ends of the elastic members have passed the hole. Immediately, the open ends of the elastic members expand outward for sandwiching the cover and the container between the head of the shaft and the open ends of the elastic members.

### FIELD OF THE INVENTION

The present invention relates to hinges and more particularly to an improved hinge for permitting a cover to swing about an industrial computer container.

### BACKGROUND OF THE INVENTION

A conventional container B for receiving an industrial computer (not shown) is illustrated in FIG. 1. As shown, the container B has a cover A coupled thereto by means of hinges C. The hinge C is implemented as a loose pin butt hinge and is comprised of two metal pieces Cl and two pairs of screws C2. Each pair of screw C2 is driven through the metal piece Cl into either the container B or the cover A.

However, the prior art hinge structure suffered from several disadvantages. For example, the positioning of the hinges with respect to both the cover and the container is not precise. Moreover, its structure is complex. Also, a mounting of the hinges on the container is not easy. Further, the hinges are visually unattractive and detract from the appearance of the container. This is particularly true if several hinges are mounted in an elongate container. Thus, the need for improvement still exists.

### SUMMARY OF THE INVENTION

It is therefore an object of the present invention to provide a novel hinge which is simple in constructions, easy to assemble, compact, and aesthetic.

To achieve the above and other objects, the present invention provides a hinge for pivotably coupling a cover to a container comprising shaft means including an enlarged head, a cylindrical body, a plurality of flats equally spaced apart around the body, and a bore having an inner thread through the body; paw means including a substantially circular abutment member, a plurality of elongate elastic members curved outward from the abutment member, a substantially circular area defined by open ends of the elastic members being slightly larger than an outer diameter of the body, and a hole through the abutment member; and fastening means, wherein the paw means is clung to the body with the elastic members aligned with the corresponding flats, the fastening means is driven through the hole into the bore to fasten the shaft means and the paw means, and the fastening means of the assembled hinge is capable of driving through the cover and the container to compress the elastic members inward until the open ends of the elastic members have passed the hole, and the open ends of the elastic members expand outward for sandwiching the cover and the container between the head of the shaft means and the open ends of the elastic members.

In one aspect of the present invention, the number of the elastic members or the flats is three.

In another aspect of the present invention, a distance between the head of the shaft means and the open ends of the elastic members is conformed to a total thickness of the container and the cover.

The above and other objects, features and advantages of the present invention will become apparent from the following detailed description taken with the accompanying drawings.

### BRIEF DESCRIPTION OF THE DRAWINGS

FIG. 1 is a perspective view of a container with two conventional hinges coupled to its cover;

FIG. 2 is a perspective view of a hinge according to a preferred embodiment of the invention;

FIG. 3 is an exploded view of the hinge shown in FIG. 2;

FIG. 4 is a schematic view illustrating a mounting of the hinge of FIG. 2 on a container; and

FIG. 5 is a perspective view of the container with the hinges of the invention mounted thereon.

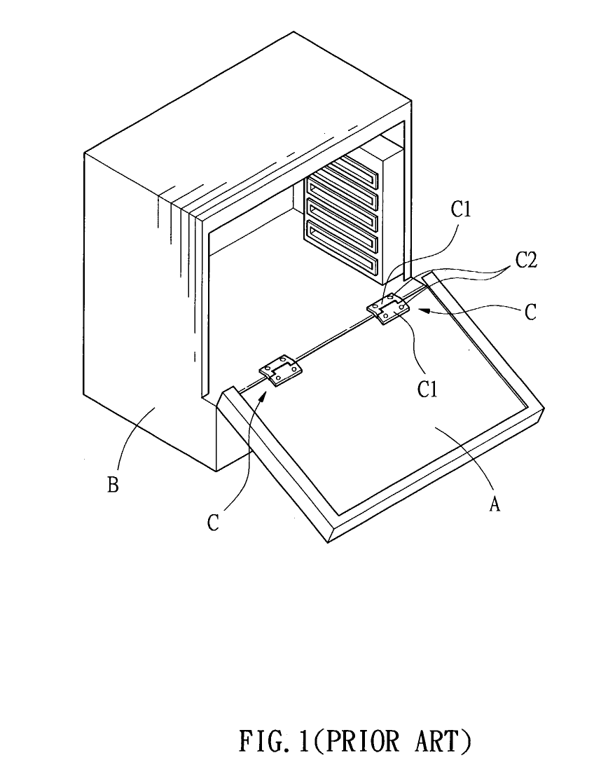

### DETAILED DESCRIPTION OF THE PREFERRED EMBODIMENTS

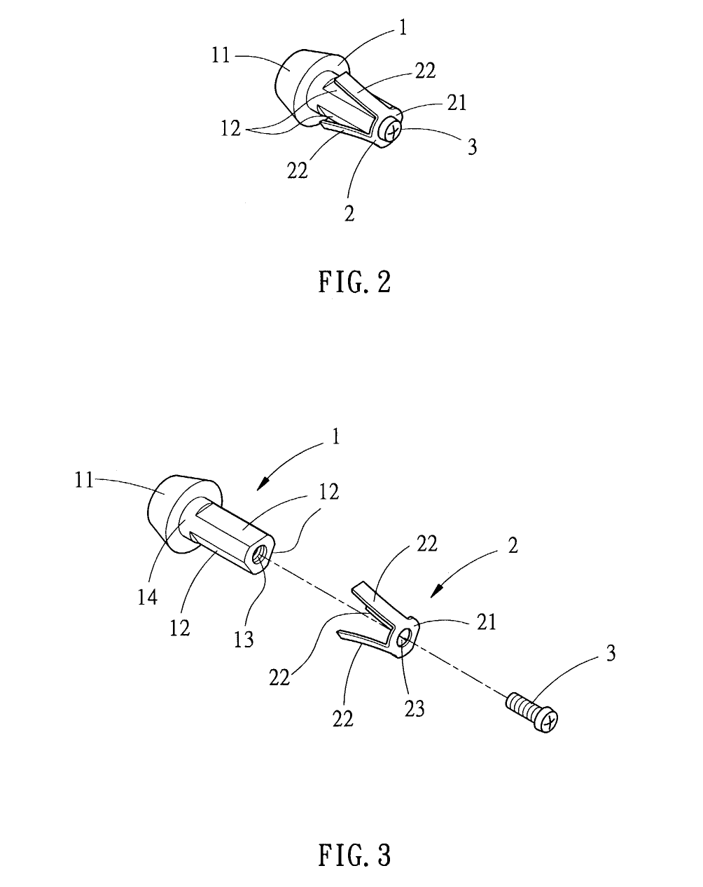

Referring to FIGS. 2 and 3, there is shown a hinge constructed in accordance with a preferred embodiment of the invention comprising a shaft unit 1 including an enlarged head 11, three flats 12 equally spaced apart around a cylindrical surface of a rear body 14, and a bore 13 having an inner thread through the body 14; a paw unit 2 including a substantially circular abutment member 21, three elongate elastic members 22 curved outward from the abutment member 21, a substantially circular area defined by open ends of the elastic members 22 being slightly larger than an outer diameter of the body 14, and a hole 23 through the abutment member 21; and a fastening unit (e.g., screw) 3. Preferably, the number of the elastic members 22 or the flats 12 is more than three. More preferably, the number of the elastic members 22 or the flats 12 is three as implemented in the embodiment.

An assembly of the invention will now be described in detail below. First, cling the paw unit 2 to the body 14 with the elastic members 22 aligned with the corresponding flats 12. Next, drive the screw 3 through the hole 23 into the bore 13 to fasten the shaft unit 1 and the paw unit 2. Preferably, a distance between the head 11 and the open ends of the elastic members 22 is conformed to a total thickness of a container and a cover as will become more apparent.

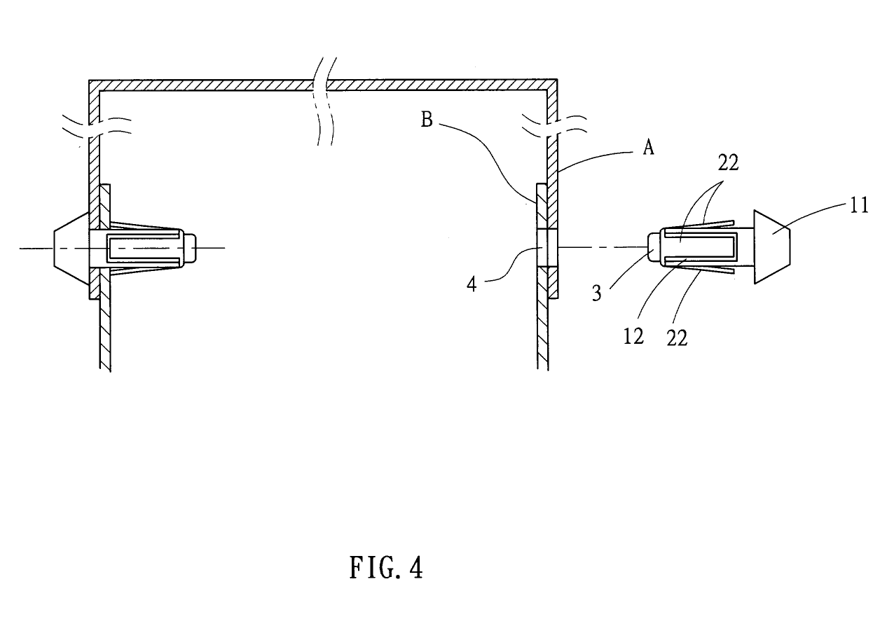

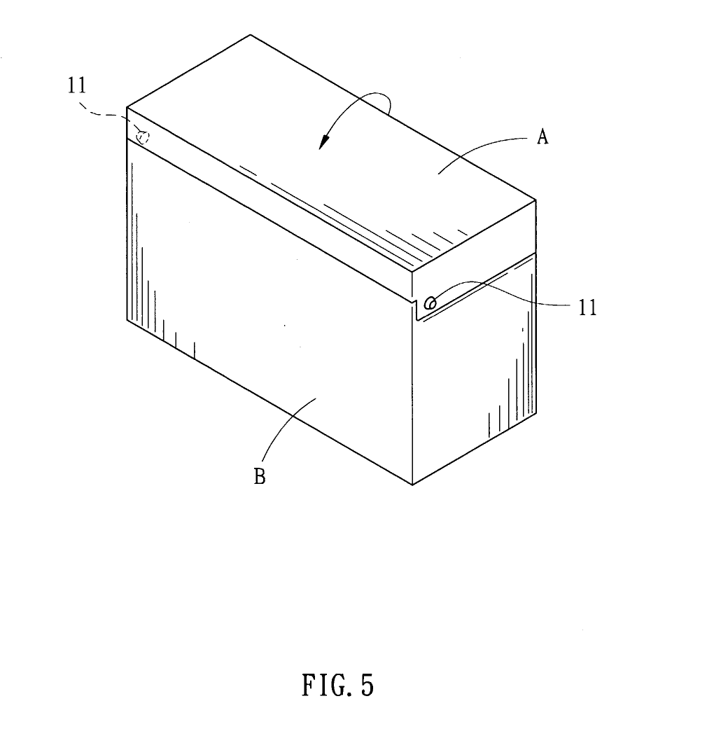

Referring to FIGS. 4 and 5, a mounting of the invention will now be described in detail below. A hole 4 is formed through a cover A and a container B. First, insert the fastening unit 3 of the assembled hinge through the hole 4 to compress the elastic members 22 inward until the open ends of the elastic members 22 have passed the hole 4. Immediately, the open ends of the elastic members 22 expand outward due to stored elastic force. As a result, the cover A and the container B are sandwiched between the head 11 and the open ends of the elastic members 22 (see left side of FIG. 4). But the cover A is still permitted to pivot about the container B for opening. As shown in FIG. 5, only the heads 11 of the hinges are projected from the cover A. Thus, the invention is compact and visually attractive.

While the invention has been described by means of specific embodiments, numerous modifications and variations could be made thereto by those skilled in the art without departing from the scope and spirit of the invention set forth in the claims.

What is claimed is:

1. A hinge for pivotably coupling a cover to a container comprising:
shaft means including an enlarged head, a cylindrical body, a plurality of flats equally spaced apart around the body, and a bore having an inner thread through the body;
paw means including a substantially circular abutment member, a plurality of elongate elastic members curved outward from the abutment member, a substantially circular area defined by open ends of the elastic members being slightly larger than an outer diameter of the body, and a hole through the abutment member; and
fastening means,
wherein the paw means is clung to the body with the elastic members aligned with the corresponding flats, the fastening means is driven through the hole into the bore to fasten the shaft means and the paw means, and the fastening means of the assembled hinge is capable of driving through the cover and the container to compress the elastic members inward until the open ends of the elastic members have passed the hole, and the open ends of the elastic members expand outward for sandwiching the cover and the container between the head of the shaft means and the open ends of the elastic members.

2. The hinge of claim 1, wherein the number of the elastic members or the flats is three.

3. The hinge of claim 1, wherein a distance between the head of the shaft means and the open ends of the elastic members is conformed to a total thickness of the container and the cover.
